(19) United States
(12) Patent Application Publication
(10) Pub. No.: US 2025/0298142 A1
(43) Pub. Date: Sep. 25, 2025

(54) COMPACT SPATIAL FILTER FOR AN OPTICAL SYSTEM

(71) Applicant: L3Harris Technologies, Inc., Melbourne, FL (US)

(72) Inventor: Edward MIESAK, Windermere, FL (US)

(21) Appl. No.: 19/077,665

(22) Filed: Mar. 12, 2025

Related U.S. Application Data
(60) Provisional application No. 63/567,150, filed on Mar. 19, 2024.

(51) Int. Cl. G01S 17/08; G02B 5/20; G02B 27/30

(52) U.S. Cl. CPC G01S 17/08; G02B 5/20; G02B 27/30

(57) ABSTRACT

An optical receiver comprises a spatial filter and an optical detector. The spatial filter comprises: a detector lens to focus collimated, incident light at a first focal point, the detector lens having a first focal length; a light barrier surface having a pinhole aperture to allow the light focused by the detector lens to pass through the light barrier surface; a re-collimation lens to collimate the light from the pinhole aperture into re-collimated light; and a re-focusing lens to focus the re-collimated light at a second focal point, the re-focusing lens having a second focal length that is shorter than the first focal length. The optical detector detects the light re-focused by the re-focusing lens.

### TECHNICAL FIELD

The present disclosure relates to a compact spatial filter for an optical system.

### BACKGROUND

Laser systems that transmit and receive laser signals are used in a variety of applications. In the context of range finding and imaging, a laser system may be required both to transmit laser signals and to receive return laser signals that are reflected and/or back scattered from objects in the system's field of view (FOV). One example is an Eye-safe Laser Range Finder (LRF), which should have a compact, rugged, and reliable design and should meet minimum performance requirements. Such systems typically are required to determine the range of objects in the FOV down to a minimum range requirement. A known design approach is to use a coaxial system in which one telescope is used to launch the laser beam and to collect the return signal. This design simplifies the system and reduces volume and cost.

Light scattering from internal optical components in a co-axial LRF can saturate the detector that detects the arrival of return laser signals. For a reflected laser signal to be detectable by the detector, the transmitting LRF laser must emit high-energy outgoing laser pulses to generate sufficient photon scattering off the target. Unless measures are taken to mitigate the internal light scattering, these out-going laser pulses may saturate the detector as they pass through and reflect off the LRF optics on their way out of the housing. More specifically, each laser pulse sent through the optical transmit train in the system may scatter off the surfaces and internal bulk of each optical element. Though each scattering site may be small, the accumulation of many scattering sites can be sufficient to saturate the detector on every laser transmit shot. The system housing itself provides additional surfaces off of which such light may scatter, thus homogenizing the scattered light inside the housing.

The duration the detector remains saturated by internal light scattering and unable to detect returning laser signals is dependent on the amount (intensity) of the internal light to which the detector is exposed. If, upon transmission of a laser pulse, the period the detector remains in saturation exceeds the shortest expected round-trip delay time of the laser pulse (i.e., resulting from reflection/back scattering off of closer objects in the field of view), the minimum range requirements of the LRF may not be met and short-range objects cannot be detected.

A prime concern of LRF design, consequently, is to minimize detector saturation due to the out-going laser pulses. LRFs deal with internal light scattering by judicious optical design, including minimizing optical scatter and applying optically absorbent coatings everywhere inside the LRF that comes into contact with scattered light. A spatial filter positioned in front of the optical detector of an LRF can significantly reduce the amount of internal light scattering that reaches the optical detector, thereby addressing the detector saturation problem. Conventional spatial filter designs, however, require significant space to operate and may be too large to implement without increasing the size of the LRF housing to an undesirable degree, since a small LRF housing may be beneficial or required in certain implementations. Thus, a compact spatial filter that can reduce internal light scatter without significantly impacting the overall size of the receiver optics would be desirable.

### BRIEF DESCRIPTION OF THE DRAWINGS

FIG. 1 is a high-level block diagram of a coaxial laser range finder (LRF) having an optical receiver.

FIG. 2 is a diagram of an optical receiver without a spatial filter to reduce the amount of internal light scattering that reaches the optical detector.

FIG. 3 illustrates the spectral filtering resulting from an optical band pass filter comprising a coating stack on a substrate.

FIG. 4 shows the presence of internal light scattering in the vicinity of the optical detector in the optical receiver design of FIG. 2.

FIG. 5 is a diagram illustrating the addition of a spatial filter to the optical receiver of FIG. 2.

FIG. 6 is a diagram showing the operation of the spatial filter of FIG. 5 in reducing the amount of internal light scattering reaching the detector.

FIG. 7 is a diagram showing the increased space requirements necessary to implement the spatial filter design illustrated in FIG. 5.

FIG. 8 is a diagram illustrating a compact spatial filter design capable of performing spatial filtering in an optical receiver with reduced space requirements compared to the implementation shown in FIG. 5.

FIG. 9 is a close-up view of the compact spatial filter lenses of FIG. 8 between the pinhole aperture and the optical detector.

FIG. 10 is a diagram showing how the optical receiver of FIG. 8, which includes a compact spatial filter, can be implemented within the same space inside an LRF housing as the optical receiver of FIG. 2, which lacks a spatial filter.

FIG. 11 is a diagram of compact spatial filter lenses in which the re-collimation lens and the re-focusing lens have a different configuration from that shown in FIG. 9.

FIG. 12 is a diagram of compact spatial filter lenses in which the re-collimation lens and the re-focusing lens have yet another configuration.

FIG. 13 is a diagram illustrating a compact spatial filter design capable of performing spatial filtering in an optical receiver with reduced space requirements compared to the implementation shown in FIG. 5, with the detector lens in a different orientation from that in FIG. 8.

### DESCRIPTION

### Overview

Disclosed is an optical receiver comprising a spatial filter and an optical detector. The spatial filter comprises: a detector lens to focus collimated, incident light at a first focal point, the detector lens having a first focal length; a light barrier surface having a pinhole aperture to allow the light focused by the detector lens to pass through the light barrier surface; a re-collimation lens to collimate the light from the pinhole aperture into re-collimated light; and a re-focusing lens to focus the re-collimated light at a second focal point, the re-focusing lens having a second focal length that is shorter than the first focal length. The optical detector detects the light re-focused by the re-focusing lens.

### Example Embodiments

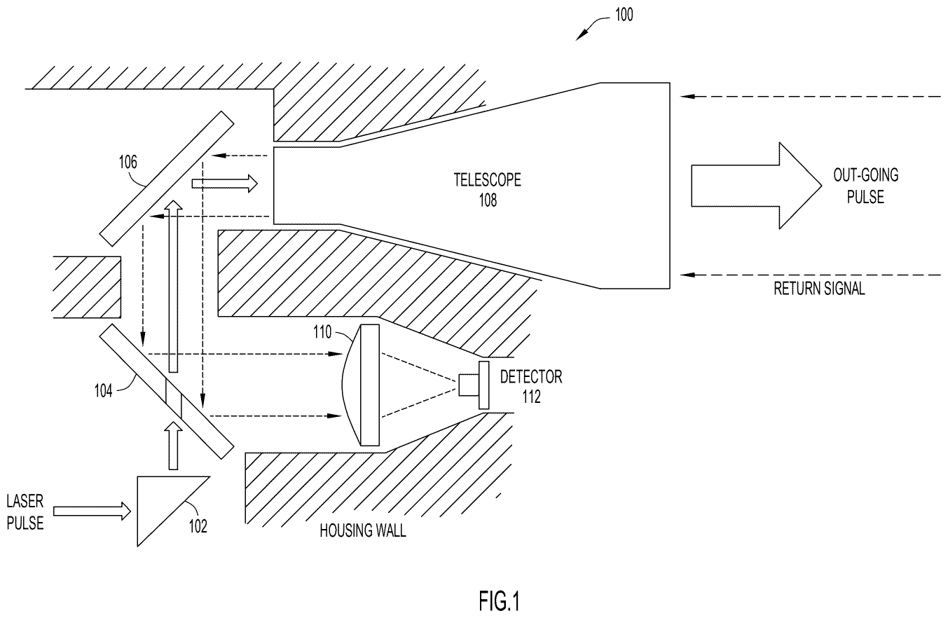

As used herein, terms such as “optical,” “optical signal,” “light,” “light beam,” “laser pulse,” “laser beam,” “laser signal,” etc., refer to electromagnetic energy at any wavelength that can be operated on by optical elements such as mirrors, lenses, polarizers, etc. Such wavelengths include those in at least the visible, infrared, and ultraviolet portions of the electromagnetic spectrum. FIG. 1 is a high-level diagram of a coaxial laser range finder (LRF) 100 in which one telescope is used to launch the laser beam and to collect the return signal. An outgoing laser pulse generated by a laser source enters a prism 102, which changes the direction of the laser pulse by 90°. In the orientation shown in FIG. 1, the laser pulse initially traveling horizontally from left to right is redirected by prism 102 to travel vertically upward. The redirected laser pulse passes through a central aperture in a first “donut” mirror 104 and reflects off a second mirror 106 oriented at 45° relative to the incident direction of the redirected laser pulse, thereby changing the direction of the laser pulse by 90°. In the example of FIG. 1, the laser pulse traveling vertically upward is reflected off second mirror 106 in a horizontal direction, thereby traveling left to right. The laser pulse reflected off second mirror 106 enters an up-collimating telescope 108 which directs the out-going laser pulse to its intended target. When the out-going laser pulse impinges on an object in the field of view, it generates a reflected/back scattered return signal, shown with dashed lines, that travels back to telescope 108 where it is captured and down-collimated. The return signal exits telescope 108 (traveling right to left in the example shown in FIG. 1) and reflects off second mirror 106 at 90° from the incident direction, traveling vertically downward in the example of FIG. 1. First mirror 104 is oriented at 45° relative the vertical direction of travel of the reflected return signal and reflects the return signal 90° such that the twice-reflected return signal travels in the horizontal direction towards an optical receiver, which includes a detector lens 110 that focuses the return signal on an optical detector 112.

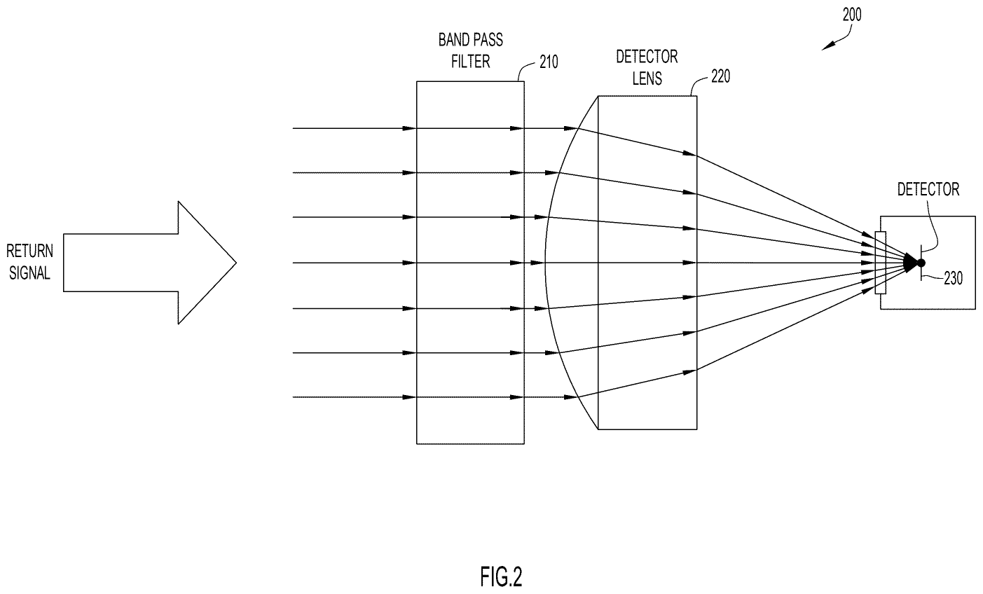

In greater detail, FIG. 2 shows an optical receiver 200 for detecting laser pulses without a spatial filter in front of the optical detector. The return laser signal passes through an optical band pass filter 210 and then passes through a detector lens 220 that focuses this light onto an optical detector 230. The Field of View (FOV) is set by the size of detector element of optical detector 230 and the focal length of detector lens 220. Specifically, the FOV for this portion of the LRF is defined as the linear dimension along one side of detector element of optical detector 230 divided by the focal length of detector lens 220.

$$FOV = \frac{Detector Dimension}{Lens Focal Length} \qquad [ 1 ]$$

Lenses used with laser light have an entrance surface for receiving incident light and an opposing exit surface through which light exits the lens. Commonly, one of the entrance and exit surfaces is a flat surface and the other of the entrance and exit surfaces is a curved surface, i.e., a planoconvex lens. A planoconvex lens typically produces the lowest optical distortion when its flat surface faces its focal point, as shown in FIG. 2.

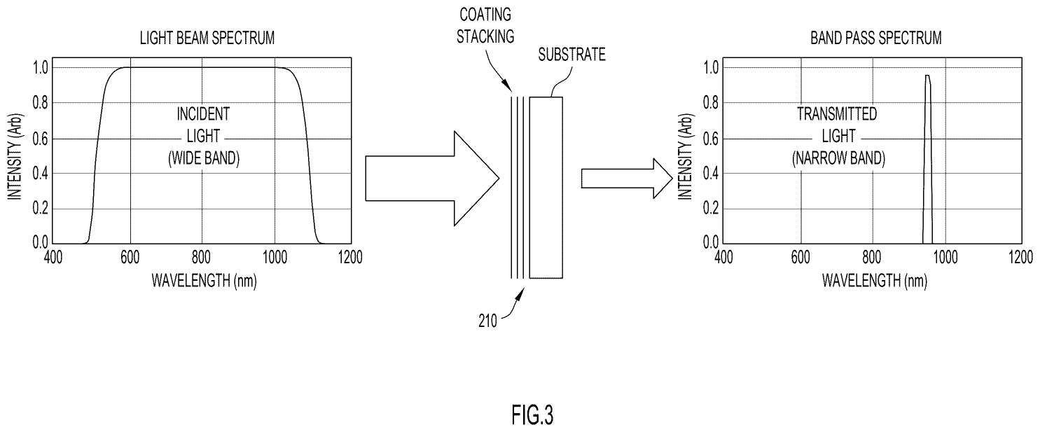

An optical band pass filter, such as optical band pass filter 210 in FIG. 2, is typically made by applying multiple optical coatings of appropriate thicknesses and indexes to an optical substrate, as shown in FIG. 3. The totality of the coatings is referred to as a “coating stack.” Light incident upon a coating stack experiences positive and negative reinforcement with the layers making up the coating stack. This reinforcement is generally referred to as interference, and interference coatings are designed to work at a specified angle of incident light. If incident light hits the coating at a different angle, it will not operate as designed. Interference is inherently path-length dependent, and forming an interference coating stack with optical coating layers of constant thickness greatly cases implementation. For these reasons, interference coatings are easier to implement and work best on flat surfaces and operate effectively on incident light that is collimated and substantially perpendicular to the surface of the coating stack. As used herein, the term “collimated” refers to light that is parallel or nearly parallel.

A band pass filter is formed if the net result of the coatings allows only one small band of wavelengths to pass completely through the coating stack. That is, the collective effect of the coating stack is that wide band, incident light is filtered such that the light transmitted through the optical band pass filter has a narrow band. In an LRF, the band pass filter is centered on the outgoing laser pulse wavelength while rejecting other wavelengths outside that band. In the example shown in FIG. 3, the band pass filter function operates on a wide band light source incident on the coating stack applied to the optical substrate. The coating stack reflects all of the incident light except for a narrow band of light centered at approximately 950 nm. In another example, the pass band of the filter can be centered at a different wavelength, e.g., 1,550 nm. In general, an optical band pass filter can be implemented to operate at virtually any optical wavelength and is designed to match the wavelength of the light to be detected by the downstream detector.

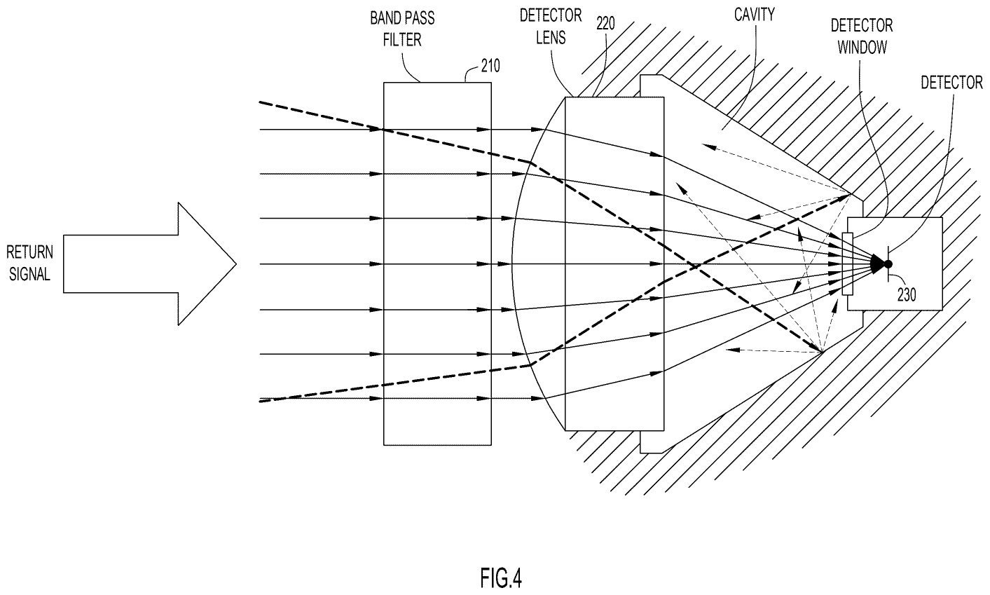

The optical receiver design shown in FIG. 2 is susceptible to scattered light, as shown in the diagram in FIG. 4. All the light that passes through optical band pass filter 210, whether scattered from the outgoing laser pulse or from the return laser signal, ends up in the cavity in front of optical detector 230. Light that is not parallel with the return signal rays will hit something in the cavity other than the detector element of optical detector 230. Light hitting the cavity walls will scatter multiple times until it is absorbed. During this time, the cavity will be filled with light. Optical detector 230 responds to this light as well as any legitimate signal that may be present. Typically, scattered light, particularly from an outgoing laser pulse, makes a stronger signal on optical detector 230 than any return signal light.

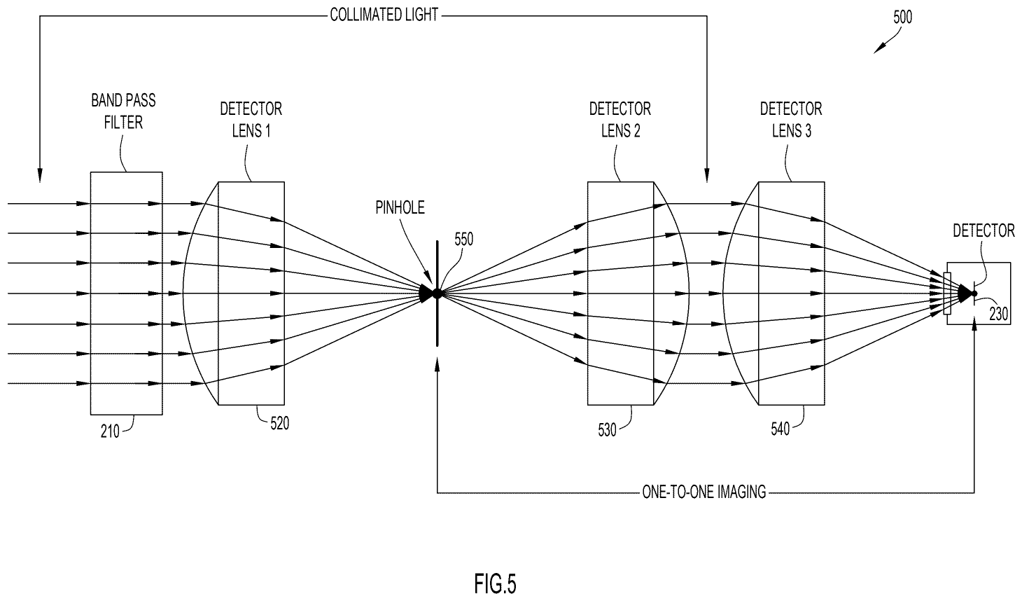

A spatial filter discriminates against light ray angles and is designed to transmit near-parallel rays coming from a specific direction. FIG. 5 shows an optical receiver having a comparable architecture to optical receiver 200 in FIG. 2 but with a multi-lens spatial filter 500 positioned in front of the optical detector 230. The spatial filter 500 includes a first detector lens 520, a second detector lens 530, a third detector lens 540, and a pinhole aperture 550 and is adapted for the purpose of an LRF. The three detector lenses are used to preserve the FOV that would result in the absence of the spatial filter. The return signal rays are nearly parallel, i.e., collimated. Normal incidence collimated light passing through band pass filter 210 is focused by first detector lens 520 and passes through pinhole aperture 550. (i.e., pinhole aperture 550 is located substantially at the focal point of first detector lens 520). Second detector lens 530 collimates the light downstream of pinhole aperture 550, and third detector lens 540 focuses this light onto optical detector 230. One-to-one imaging creates the same spot size and cone of light on optical detector 230 that is present at pinhole aperture 550, which is consistent with optical detector 230 being at the location of pinhole aperture 550 in the absence of spatial filter 500. All three lenses 520, 530, and 540 of spatial filter 500 have their flat surfaces facing their respective focal points in order to minimize optical distortion to keep the spot size on optical detector 230 the same as at pinhole aperture 550.

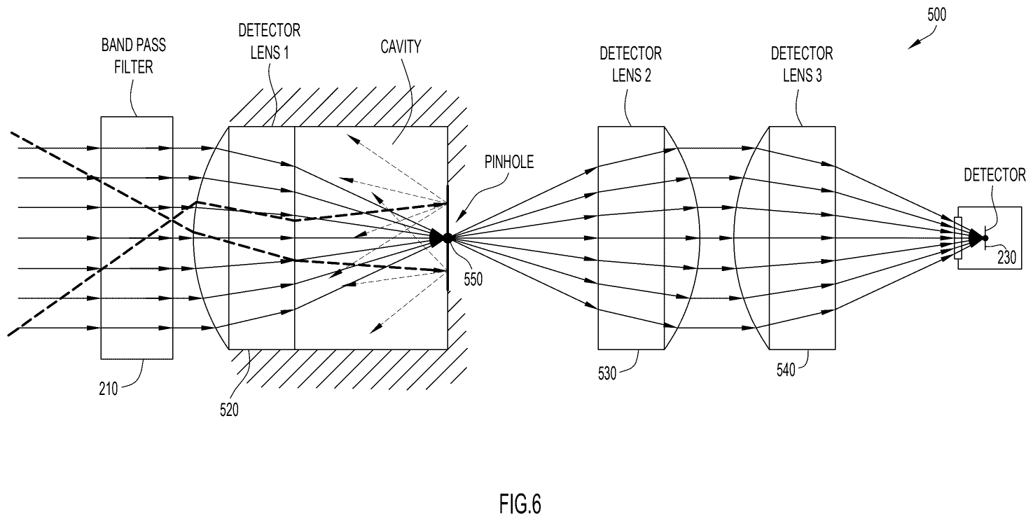

Scattered light contains a wide variety of ray angles. The return signal is collimated and has a very small variety of ray angles. Any rays not parallel or nearly parallel with the axis of a spatial filter will not pass the pinhole, but the return signal will easily pass through the pinhole. For the optical receiver shown in FIG. 5, FIG. 6 illustrates the reflection of light at pinhole aperture 550 that passes through band pass filter 210 but is not parallel or nearly parallel with the axis of spatial filter 500. All the light passing through band pass filter 210 ends up in the cavity in front of the pinhole, but only rays parallel or nearly parallel with the return signal will pass through pinhole aperture 550 and illuminate optical detector 230. This arrangement greatly reduces scattered light reaching optical detector 230 in the optical receiver of FIG. 6.

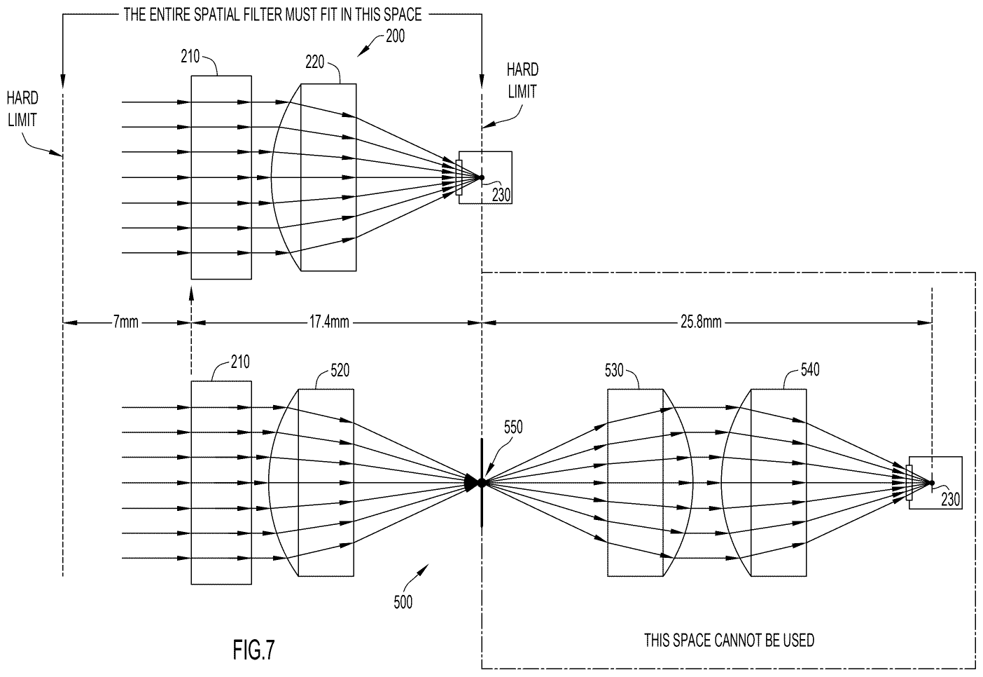

While the spatial filter arrangement shown in FIGS. 5 and 6 is capable of reducing the amount of internal light scattering that reaches the detector, inclusion of this spatial filter significantly increases the space required within the LRF housing to accommodate the receiver optics. FIG. 7 illustrates a non-limiting example of the impact of adding such a spatial filter in a space-constrained housing. The top diagram shown in FIG. 7 shows the optical receiver of FIG. 2 (i.e., band pass filter 210, detector lens 220, and optical detector 230, but without a spatial filter) positioned within a space-constrained portion of an LRF housing. In this example, the length of the space allocated for the optical receiver in the direction of the return signal is 24.4 mm. The bottom diagram in FIG. 7 shows the optical receiver of FIG. 5 in which spatial filter 500 has been added to the optical receiver arrangement of FIG. 2. In essence, this design requires three detector lenses like the one detector lens in the non-spatial-filter design shown at the top of FIG. 7 to perform the spatial filtering. While this spatial filter design addresses the problem of internal light scattering reaching optical detector 230, spatial filter 500 requires an additional length of 25.8 mm in the direction of the return signal, all of which exceeds the space available in the LRF housing in this example.

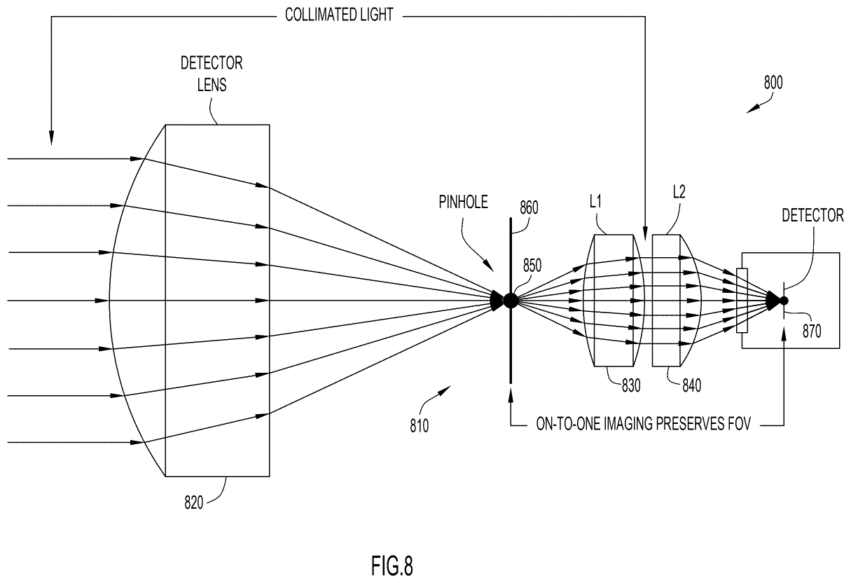

FIG. 8 illustrates a compact spatial filter 810 that accomplishes the desired spatial filtering in an optical receiver 800 without requiring additional space within an LRF housing relative to the optical receiver design shown in FIG. 2, which lacks a spatial filter. The compact spatial filter 810 comprises three lenses. The first lens is a planoconvex detector lens 820 that can be essentially the same as detector lens 220 of optical receiver 200 shown in FIG. 2, which preserves the FOV relative to that design. Detector lens 820 focuses collimated, incident light at a first focal point, and has a first focal length. As shown in FIG. 8, the curved surface of detector lens 820 is on the input side and receives the collimated, incident light of the return laser pulse, while the planar surface of detector lens 820 is on the output side where the output light converges at the first focal point of detector lens 820. Note that a separate optical band pass filter, which filters incident light to a desired, narrow band of wavelengths prior to reaching detector lens 820 (i.e., a pre-bandpass filter), is omitted in the design shown in FIG. 8.

Compact spatial filter 810 further includes a light barrier surface 860 (e.g., a wall whose surface is impenetrable to light present in the optical receiver) on an output side of detector lens 820 that is substantially parallel to the output surface of detector lens 820 and is located at a distance from detector lens 820 that coincides with the distance of the first focal point from detector lens 820. Light barrier surface 860 includes a pinhole aperture 850 that coincides with the first focal point of detector lens 820 to allow collimated light passing through detector lens 820 to pass through light barrier surface 860 towards an optical detector 870. Light barrier surface 860 is otherwise impenetrable to incident light (i.e., light of any wavelength reaching light barrier surface 860 at any location other than pinhole aperture 850 is either absorbed or reflected. As with pinhole aperture 550 shown in FIGS. 5 and 6, light entering detector lens 820 that is not collimated (parallel or nearly parallel to the return laser light) will not arrive at the focal point of detector lens 820 and will not pass through pinhole aperture 850. Note that, because optical band pass filtering is not performed upstream of pinhole aperture 850, it is possible for undesired light outside the narrow band surrounding the wavelength of the return laser signal to pass through pinhole aperture 850.

Referring again to FIG. 8, compact spatial filter 810 further includes two additional lenses, re-collimation lens 830 and re-focusing lens 840, which are positioned in succession in the optical path between pinhole aperture 850 and optical detector 870. The function of re-collimation lens 830 is to collimate the received light downstream of pinhole aperture 850. The re-collimated light should resemble the return signal at the front (input) surface of detector lens 820, i.e., have the same collimation. The function of re-focusing lens 840 is to focus the received light on the detector element of optical detector 870 with the same cone angle as that created by detector lens 820, thus preserving the system's receive FOV. Lenses 830, 840 have significantly shorter focal lengths than the first focal length of detector lens 820, and the focal lengths of re-collimation lens 830 and re-focusing lens 840 are equal or nearly equal to each other in order to preserve the receive FOV provided by detector lens 820 and to generate a one-to-one image relay (one-to-one imaging) from the input of re-collimation lens 830 to the output of re-focusing lens 840. According to a non-limiting example, the focal lengths of lenses 830, 840 can be on the order of a few millimeters, e.g., 5-8 mm, which can be less than half the focal length of detector lens 820. The three lenses (detector lens 820, re-collimation lens 830, and re-focusing lens 840) work together to produce minimal optical distortion, thus reproducing the spot size at pinhole aperture 850 on the detector element of optical detector 870.

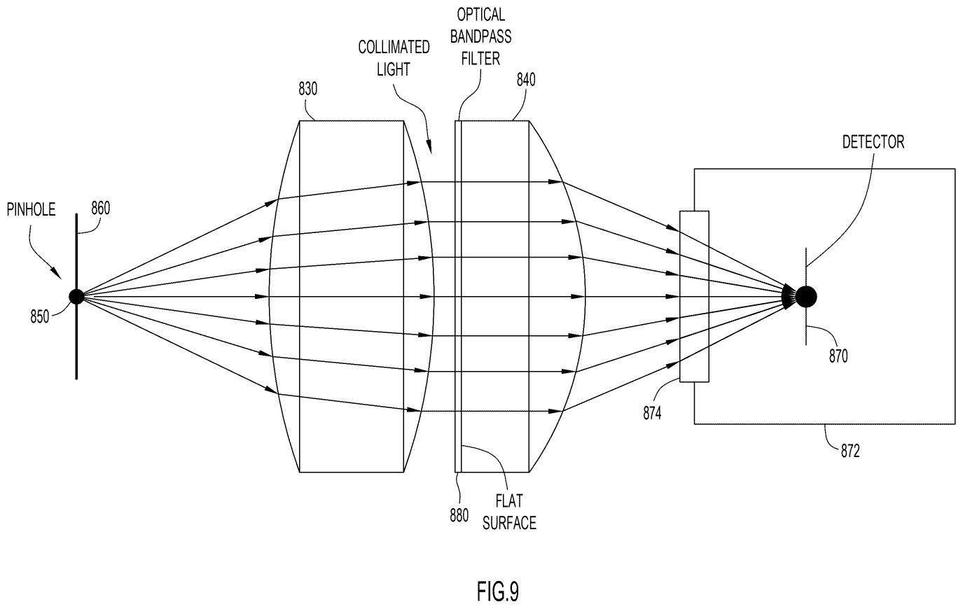

Re-collimation lens 830 receives incident light that has traveled through pinhole aperture 850 and produces collimated light at its output surface. As best seen in the close-up in FIG. 9, this result can be accomplished by re-collimation lens 830 having convex input and output surfaces (a double-convex lens), the curvatures of which collectively refract the diverging light beam from pinhole aperture 850 to produce collimated light at the output of re-collimation lens 830. Re-focusing lens 840 is a planoconvex lens with a planar input surface facing re-collimation lens 830 (i.e., on the input side, opposite the side facing optical detector 870 and the focal point of re-focusing lens 840) that receives collimated light from the output of re-collimation lens 830, and a convex output surface (e.g., a parabolic curvature) on the side of optical detector 870. Re-focusing lens 840 refracts the re-collimated light into a converging light beam that is focused at a second focal point, which is coincident with the surface of the detector element of optical detector 870. Re-focusing lens 840 has a second focal length that is shorter than the first focal length of detector lens 820, as previously indicated. Optical detector 870 is located in a detector housing 872 and receives and detects the re-focused light from re-focusing lens 840 through a window 874 (shown to the left of optical detector 870 in FIG. 9).

As seen in FIG. 9, light traveling in the space between re-collimation lens 830 and re-focusing lens 840 is collimated, and the input surface of re-focusing lens 840 is planar and substantially perpendicular to the collimated light incident on re-focusing lens 840. The significance of the light traveling between lenses 830 and 840 being collimated and substantially perpendicular to the input surface of re-focusing lens 840 is that the planar surface of re-focusing lens 840 can be used as a substrate to accommodate a coating stack that forms an optical band pass filter 880. By forming optical band pass filter 880 on the planar input surface of re-focusing lens 840, the need for a separate substrate to accommodate an optical interference band pass filter, like that shown in FIG. 2, is eliminated, thereby reducing the length required to house optical receiver 800. Optical band pass filter 880 can comprise multiple optical coatings of appropriate thicknesses and indexes formed on the flat input surface of re-focusing lens 840, the totality of which is an interference “coating stack” as previously described. Optical band pass filter 880 allows only a small band of wavelengths to pass completely through the coating stack, and the pass band is selected to be centered on the laser pulse wavelength while rejecting other wavelengths outside that band.

Orienting the flat input surface of re-focusing lens 840 to be on the side facing the re-collimated light from re-collimation lens 830 rather than the side facing the re-focusing lens' focal point (i.e., towards optical detector 870) is unconventional, because this orientation causes a higher degree of optical distortion than the conventional orientation in which the flat surface of a planoconvex lens is positioned on the side of the lens where light is converging to or diverging from the lens' focal point. As seen, for example, in spatial filter 500 of FIG. 5, all three lenses 520, 530, and 540 have their curved faces oriented on the collimated-light-side of the lens and their flat faces oriented on the side of the lens facing the focal point (i.e., the converging/diverging-light-side of the lens). While the increased optical distortion caused by the orientation of re-focusing lens 840 is somewhat disadvantageous, this arrangement allows an optical band pass filter to be introduced in compact spatial filter 810 without adding another discrete optical element. As previously described, because interference is inherently path-length dependent, and the interference coatings of an interference optical band pass filter are designed to work at a specified angle of incident light, locating an interference coating stack on a flat surface which receives incident light that is collimated and substantially perpendicular to the surface of the coating stack with optical coating layers of constant thickness greatly cases implementation.

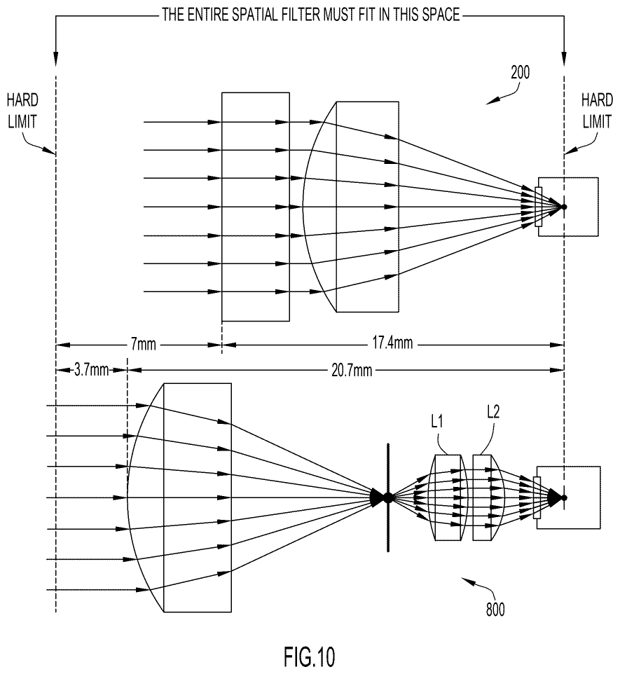

FIG. 10 illustrates a non-limiting example of the space savings resulting from implementation of optical receiver 800 with compact spatial filter 810 in an optical receiver housing. The top diagram shown in FIG. 10, which is the same as that depicted in FIG. 7, shows optical receiver 200 of FIG. 2 (i.e., a band pass filter 210, a detector lens 220, and an optical detector 230, but without a spatial filter) positioned within a space-constrained portion of an LRF housing. As previously described, in this example, the length of the space allocated for optical receiver 200 in the direction of the return signal is 24.4 mm. The bottom diagram in FIG. 10 shows optical receiver 800 of FIG. 8 in which the disclosed compact spatial filter 810 can be implemented without requiring any additional space within the LRF housing required for optical receiver 200 shown in FIG. 2, while preserving the FOV of optical receiver 200.

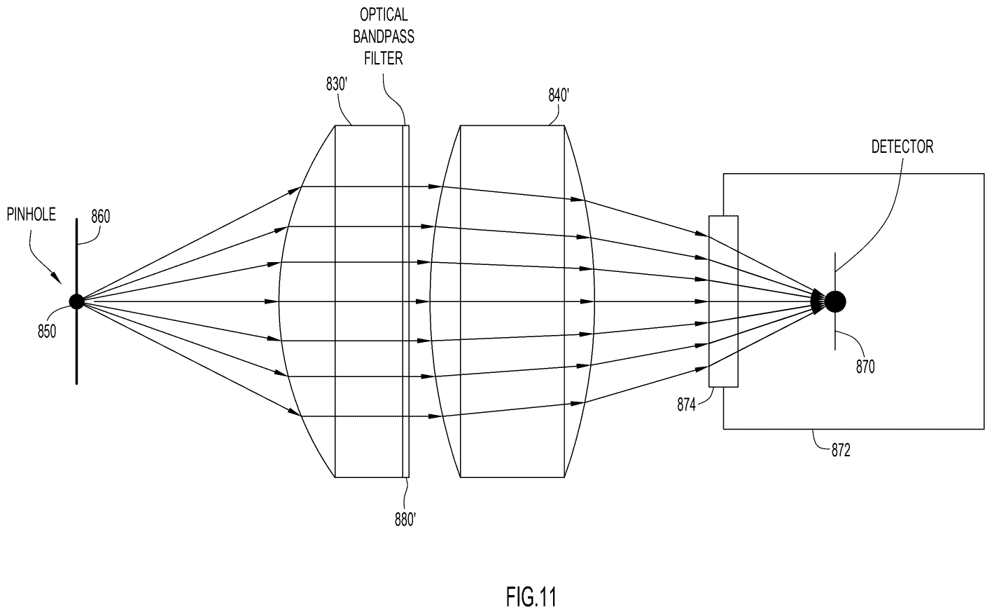

According to another implementation shown in FIG. 11, a re-collimation lens 830′ and a re-focusing lens 840′ are arranged in sequence between pinhole aperture 850 and optical detector 870. Re-collimation lens 830′ is a planoconvex lens with a convex input surface (on the side of pinhole aperture 850 and the focal point of re-collimation lens 830′) and a planar output surface on the output side (on the side facing re-focusing lens 840 and the re-collimated light). The curvature of the input surface of re-collimation lens 830′ results in collimated light exiting re-collimation lens 830′ through and parallel to the flat surface on the output side of re-collimation lens 830′. Re-focusing lens 840′ has convex input and output surfaces (a double-convex lens), the curvatures of which collectively refract the collimated light incident on re-focusing lens 840′ from re-collimation lens 830′ to produce a converging light beam that exits re-focusing lens 840′ and converges at a focal point located at the detection element of optical detector 870. In this arrangement, an interference coating stack optical band pass filter 880′ is disposed on the flat (planar) output surface of re-collimation lens 830′ to allow only a small band of wavelengths to pass completely through the coating stack, and the pass band is selected to be centered on the laser pulse wavelength while rejecting other wavelengths outside that band.

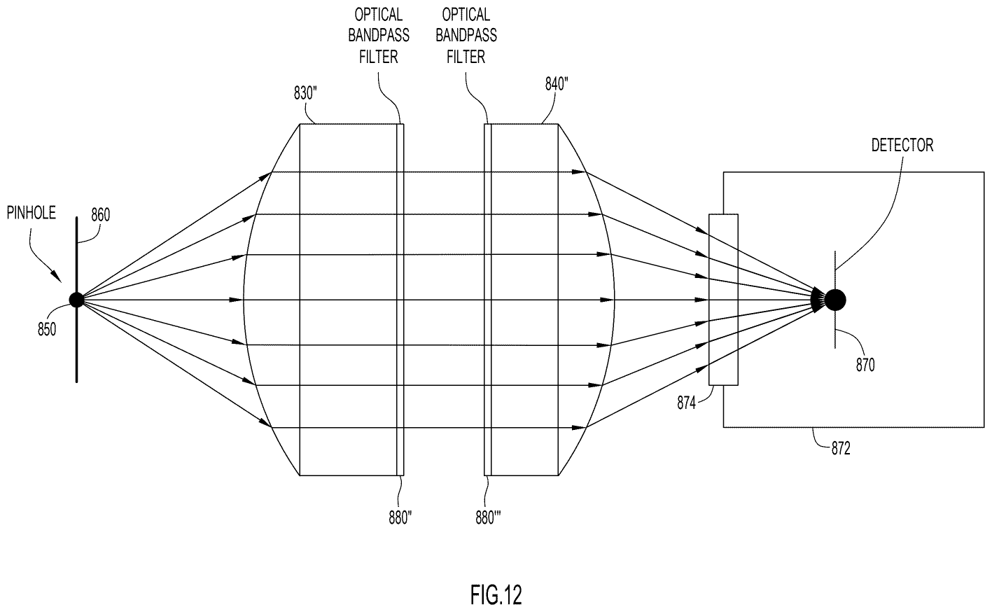

According to yet another implementation shown in FIG. 12, a re-collimation lens 830″ and a re-focusing lens 840″ are arranged in sequence between pinhole aperture 850 and optical detector 870. Both re-collimation lens 830″ and re-focusing lens 840″ are planoconvex lenses in this case. Re-collimation lens 830″ has a convex input surface facing pinhole aperture 850 and the focal point of re-collimation lens 830″, which is co-located with pinhole aperture 850. Re-collimation lens 830″ refracts the incoming diverging input light beam received from pinhole aperture 850 to produce a collimated light beam at its planar output surface (on the side facing re-focusing lens 840″ and the re-collimated light beam, and opposite the side of the focal point of re-collimation lens 830″). Re-focusing lens 840″ has a planar input surface on the side facing re-collimation lens 830″, and opposite the side on which the focal point of re-focusing lens 840″ lies, which receives the collimated light beam from re-collimation lens 830″. Re-focusing lens 840″ further has a convex output surface on the side facing the focal point of re-focusing lens 840″ and optical detector 870, which refracts the collimated light into a converging light beam with a focal point coincident with the detection element of optical detector 870. In this arrangement, an interference coating stack optical band pass filter 880″ is disposed on the flat (planar) output surface of re-collimation lens 830′ and another optical band pass filter 880′″ is disposed on the flat (planar) input surface of re-focusing lens 840″. According to another option, an optical band pass filter can be located on only the planar output surface of re-collimation lens 830″ or on only the planar input surface of re-focusing lens 840″. Collectively, optical band pass filters 880″, 880″ allow only a small band of wavelengths to pass completely through the two coating stacks, and the pass band is selected to be centered on the wavelength of the laser pulse light while rejecting other wavelengths outside that band.

Summarizing, in the aforementioned implementations shown in FIGS. 9, 11, and 12, light traveling in the space between re-collimation lens 830, 830′, 830″ and re-focusing lens 840, 840′, and 840″ is collimated, and the output surface of re-collimation lens (830′, 830″) or the input surface of re-focusing lens (840, 840″) or both are planar. The significance of at least one of the lens surfaces bounding the space between the re-collimation lens and the re-focusing lens being planar and the light traveling between the re-collimation lens and the re-focusing lens being collimated and substantially perpendicular to the planar surface is that the planar surface of re-collimation lens (830′, 830″) or re-focusing lens (840, 840″), or both, can be used as a substrate to accommodate a coating stack that forms an interference optical band pass filter. By forming the optical band pass filter (880, 880′, 880″, 880″) on one of the planar lens surfaces bounding the space between the re-collimation lens and the re-focusing lens, the need for a separate substrate to accommodate the band pass interference filter, like that shown in FIG. 2, is eliminated, thereby reducing the length required to house the optical receiver. Thus, while orienting the flat surface of the re-collimation lens and/or the re-focusing lens to be on the side of the lens facing collimated light rather than on the side facing the lens' focal point causes a higher degree of optical distortion, orienting the flat (planar) surface of either or both lenses in this manner facilitates locating an optical band pass filter on the flat surface of the lens.

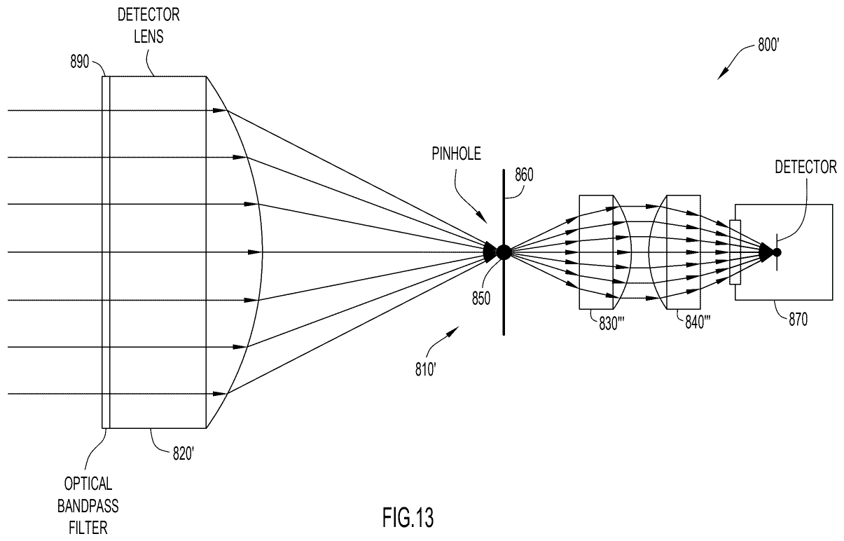

FIG. 13 illustrates an implementation of an optical receiver 800′ with a compact spatial filter 810′ in which the orientation of the detector lens is flipped relative to the orientation of detector lens 820 shown in FIG. 8. In this example, a planoconvex detector lens 820′ is oriented such that the planar surface of detector lens 820′ is on the input side and receives the collimated, incident light of the return laser pulse, while the convex surface of detector lens 820′ is on the output side where the output light converges at the focal point of detector lens 820′ (at pinhole aperture 850). In this arrangement, because the flat (planar) side of detector lens 820′ faces and is substantially perpendicular to the collimated, incident light, an optical band pass filter 890 can be located on the planar input surface of detector lens 820′. Optical band pass filter 890 can comprise multiple optical coatings of appropriate thicknesses and indexes formed on the flat input surface of detector lens 820′, the totality of which is an interference “coating stack” as previously described. Note that the optical distortion resulting from this flipped orientation of detector lens 820′ is higher than that in the conventional orientation shown in FIG. 8 but nevertheless may be at an acceptable level and allows the optical band pass filter 890 to be formed on the detector lens and avoids the need for a separate optical element for the optical band pass filter.

Optical band pass filter 890 on the flat, input side of detector lens 820′ can be implemented in addition to or instead of the optical band pass filter coatings on the re-collimation lens or the re-focusing lens (or both). In general, any of the three lenses (the detector lens, the re-collimation lens, and the re-focusing lens) whose planar surface is in a collimated space (i.e., facing a location in which the light is collimated), and substantially perpendicular to the collimated light, can be used as a location for an optical band pass filter implemented as a coating stack on the flat surface. In this manner, coating stacks in two or three locations can be used to enhance band pass filter performance.

In summary, re-collimation lens 830, 830′, 830″ and re-focusing lens 840, 840′, 840″ are designed to work in conjunction with detector lens 820, 820′ to produce minimal optical distortion to the light falling on optical detector 870 while simultaneously providing at least one flat surface that receives collimated, perpendicular light on which an interference optical band pass filter (880, 880′, 880″, 880″, 890) can be located. Typically, the flat surface of a planoconvex lens faces its focal point. In the described examples, the flat surface of the planoconvex lens faces the opposite direction, i.e., the planar surface of the lens is on the opposite side of the lens from the focal point. Specifically, in FIGS. 8 and 9, re-focusing lens 840 generates a focal point on the output side of the lens, i.e., facing optical detector 870, whereas the planar surface of re-focusing lens 840 is located on the input side (facing re-collimation lens 830) and opposite the output side where the focal point is located. Likewise, in the alternative examples in which the re-collimation lens 830′, 830″ is planoconvex, the focal point of the re-collimation lens is on the input side (facing the pinhole aperture), whereas the planar surface of re-collimation lens is located on the output side) facing the re-focusing lens. Moreover, the detector lens can also be oriented with its planar surface facing the input light from the return laser signal. In each case, by locating the planar surface of the lens on the side opposite to the lens' focal point and on the side adjacent to collimated light, the planar surface of the lens can be used a surface to arrange an optical band pass filter implemented as an interference coating stack.

While the compact spatial filter and the optical receiver implemented with a compact spatial filter have been described in the context of a Laser Range Finder (LRF), it will be appreciated that the described compact spatial filter is not limited to applications in an LRF. The described compact spatial filter provides beneficial filtering in any of a wide variety of imaging systems that employ electromagnetic signals, including medical imaging systems.

In some aspects, the techniques described herein relate to an optical receiver comprising a spatial filter and an optical detector. The spatial filter comprises: a detector lens to focus collimated, incident light at a first focal point, the detector lens having a first focal length; a light barrier surface having a pinhole aperture to allow the light focused by the detector lens to pass through the light barrier surface; a re-collimation lens to collimate the light from the pinhole aperture into re-collimated light; and a re-focusing lens to focus the re-collimated light at a second focal point, the re-focusing lens having a second focal length that is shorter than the first focal length. The optical detector detects the light re-focused by the re-focusing lens.

In some aspects, the techniques described herein relate to an optical receiver, wherein at least one of the detector lens, the re-collimation lens, and the re-focusing lens has a planar surface facing and substantially perpendicular to collimated light.

In some aspects, the techniques described herein relate to an optical receiver further comprising an optical band pass filter on the planar surface.

In some aspects, the techniques described herein relate to an optical receiver, wherein the re-focusing lens is a planoconvex lens having: a planar input surface facing the re-collimation lens and substantially perpendicular to the re-collimated light, and a convex output surface facing the second focal point, and the optical receiver further comprises an optical band pass filter on the planar input surface of the re-focusing lens.

In some aspects, the techniques described herein relate to an optical receiver, wherein the re-collimation lens is a planoconvex lens having: a planar output surface facing the re-focusing lens and substantially perpendicular to the re-collimated light, and a convex input surface facing the pinhole aperture and a focal point of the re-collimation lens, and the optical receiver further comprises an optical band pass filter on the planar output surface of the re-collimation lens.

In some aspects, the techniques described herein relate to an optical receiver, wherein the detector lens is a planoconvex lens having: a planar input surface substantially perpendicular to the collimated, incident light, and a convex output surface facing the first focal point, and the optical receiver further comprised an optical band pass filter on the planar input surface of the detector lens.

In some aspects, the techniques described herein relate to an optical receiver, wherein the re-focusing lens re-focuses the re-collimated light on the optical detector with a same cone angle as the detector lens focuses the collimated, incident light on the pinhole aperture to preserve a field of view of the optical detector provided by the detector lens.

In some aspects, the techniques described herein relate to an optical receiver, wherein a focal length of the re-collimation lens is substantially the same as the second focal length to generate a one-to-one image relay from an input of the re-collimation lens to an output of the re-focusing lens.

In some aspects, the techniques described herein relate to an optical receiver, wherein the first focal point and a focal point of the re-collimation lens are located at the pinhole aperture, and the re-collimation lens has a third focal length that is shorter than the first focal length.

In some aspects, the techniques described herein relate to an optical receiver, wherein the re-collimation lens has a third focal length that is shorter than the first focal length, and wherein the second and third focal lengths are substantially the same.

In some aspects, the techniques described herein relate to a coaxial laser range finder, comprising an optical receiver including a spatial filter, an optical detector, a telescope, and optical elements. The spatial filter comprises: a detector lens to focus collimated, incident light at a first focal point, the detector lens having a first focal length; a light barrier surface having a pinhole aperture to allow the light focused by the detector lens to pass through the light barrier surface; a re-collimation lens to collimate the light from the pinhole aperture into re-collimated light; and a re-focusing lens to focus the re-collimated light at a second focal point, the re-focusing lens having a second focal length that is shorter than the first focal length. The optical detector detects the light re-focused by the re-focusing lens. The telescope launches a laser signal and collects a return signal of the laser signal reflected from an object, and the optical elements direct the return signal to the detector lens as the collimated, incident light.

In some aspects, the techniques described herein relate to an imaging system comprising: an optical receiver, including a spatial filter and an optical detector; and optical elements. The spatial filter comprises: a detector lens to focus collimated, incident light at a first focal point, the detector lens having a first focal length; a light barrier surface having a pinhole aperture to allow the light focused by the detector lens to pass through the light barrier surface; a re-collimation lens to collimate the light from the pinhole aperture into re-collimated light; and a re-focusing lens to focus the re-collimated light at a second focal point, the re-focusing lens having a second focal length that is shorter than the first focal length. The optical detector detects the light re-focused by the re-focusing lens. The optical elements direct the collimated, incident light to the detector lens.

In some aspects, the techniques described herein relate to a laser range finder comprising: a telescope to launch a laser signal and to collect a return signal of the laser signal reflected from an object, and a spatial filter comprising: a detector lens to focus the return signal at a first focal point, the detector lens having a first focal length; a light barrier surface having a pinhole aperture to allow the return signal focused by the detector lens to pass through the light barrier surface; a re-collimation lens to collimate the return signal from the pinhole aperture into a re-collimated return signal; and a re-focusing lens to focus the re-collimated return signal at a second focal point, the re-focusing lens having a second focal length that is shorter than the first focal length. The laser range finder further comprises an optical detector to detect the return signal re-focused by the re-focusing lens.

In some aspects, the techniques described herein relate to a laser range finder, wherein the telescope is a collimating telescope that up-collimates the laser signal and down-collimates the return signal such that the return signal incident on the detector lens is collimated.

In some aspects, the techniques described herein relate to a laser range finder, wherein at least one of the detector lens, the re-collimation lens and the re-focusing lens has a planar surface facing and substantially perpendicular to the return signal in a collimated state, and the laser range finder further comprises an optical band pass filter on the planar surface.

In some aspects, the techniques described herein relate to a laser range finder, wherein the detector lens is a planoconvex lens having a planar input surface substantially perpendicular to the return signal, and a convex output surface facing the first focal point, and the laser range finder further comprises an optical band pass filter on the planar input surface of the detector lens.

In some aspects, the techniques described herein relate to a laser range finder, wherein a focal length of the re-collimation lens is substantially the same as the second focal length to generate a one-to-one image relay from an input of re-collimation lens to an output of re-focusing lens.

In some aspects, the techniques described herein relate to a spatial filter comprising: a detector lens to focus collimated, incident light at a first focal point, the detector lens having a first focal length; a light barrier surface having a pinhole aperture to allow light focused by the detector lens to pass through the light barrier surface; a re-collimation lens to collimate the light from the pinhole aperture into re-collimated light; and a re-focusing lens to focus the re-collimated light at a second focal point, the re-focusing lens having a second focal length that is shorter than the first focal length.

In some aspects, the techniques described herein relate to a spatial filter, wherein at least one of the detector lens, the re-collimation lens and the re-focusing lens has a planar surface facing and substantially perpendicular to collimated light, and the spatial filter further comprises an optical band pass filter on the planar surface.

In some aspects, the techniques described herein relate to a spatial filter, wherein the detector lens is a planoconvex lens having a planar input surface substantially perpendicular to the collimated, incident light, and a convex output surface facing the first focal point, and the spatial filter further comprises an optical band pass filter on the planar input surface of the detector lens.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. An optical receiver, comprising:
a spatial filter comprising:
a detector lens to focus collimated, incident light at a first focal point, the detector lens having a first focal length;
a light barrier surface having a pinhole aperture to allow the light focused by the detector lens to pass through the light barrier surface;
a re-collimation lens to collimate the light from the pinhole aperture into re-collimated light; and
a re-focusing lens to focus the re-collimated light at a second focal point, the re-focusing lens having a second focal length that is shorter than the first focal length; and
an optical detector to detect light re-focused by the re-focusing lens.

2. The optical receiver of claim 1, wherein at least one of the detector lens, the re-collimation lens, and the re-focusing lens has a planar surface facing and substantially perpendicular to collimated light.

3. The optical receiver of claim 2, further comprising an optical band pass filter on the planar surface.

4. The optical receiver of claim 2, wherein the re-focusing lens is a planoconvex lens having: a planar input surface facing the re-collimation lens and substantially perpendicular to the re-collimated light, and a convex output surface facing the second focal point, the optical receiver further comprising:
an optical band pass filter on the planar input surface of the re-focusing lens.

5. The optical receiver of claim 2, wherein the re-collimation lens is a planoconvex lens having: a planar output surface facing the re-focusing lens and substantially perpendicular to the re-collimated light, and a convex input surface facing the pinhole aperture and a focal point of the re-collimation lens, the optical receiver further comprising:
an optical band pass filter on the planar output surface of the re-collimation lens.

6. The optical receiver of claim 2, wherein the detector lens is a planoconvex lens having: a planar input surface substantially perpendicular to the collimated, incident light, and a convex output surface facing the first focal point, the optical receiver further comprising:
an optical band pass filter on the planar input surface of the detector lens.

7. The optical receiver of claim 1, wherein the re-focusing lens re-focuses the re-collimated light on the optical detector with a same cone angle as the detector lens focuses the collimated, incident light on the pinhole aperture to preserve a field of view of the optical detector provided by the detector lens.

8. The optical receiver of claim 1, wherein a focal length of the re-collimation lens is substantially the same as the second focal length to generate a one-to-one image relay from an input of the re-collimation lens to an output of the re-focusing lens.

9. The optical receiver of claim 1, wherein the first focal point and a focal point of the re-collimation lens are located at the pinhole aperture, the re-collimation lens having a third focal length that is shorter than the first focal length.

10. The optical receiver of claim 1, wherein the the re-collimation lens has a third focal length that is shorter than the first focal length, and wherein the second and third focal lengths are substantially the same.

11. A coaxial laser range finder, comprising:
the optical receiver of claim 1;
a telescope to launch a laser signal and to collect a return signal of the laser signal reflected from an object; and
optical elements to direct the return signal to the detector lens as the collimated, incident light.

12. An imaging system, comprising:
the optical receiver of claim 1; and
optical elements to direct the collimated, incident light to the detector lens.

13. A laser range finder, comprising:
a telescope to launch a laser signal and to collect a return signal of the laser signal reflected from an object;
a spatial filter comprising:
a detector lens to focus the return signal at a first focal point, the detector lens having a first focal length;
a light barrier surface having a pinhole aperture to allow the return signal focused by the detector lens to pass through the light barrier surface;
a re-collimation lens to collimate the return signal from the pinhole aperture into a re-collimated return signal; and
a re-focusing lens to focus the re-collimated return signal at a second focal point, the re-focusing lens having a second focal length that is shorter than the first focal length; and
an optical detector to detect the return signal re-focused by the re-focusing lens.

14. The laser range finder of claim 13, wherein the telescope is a collimating telescope that up-collimates the laser signal and down-collimates the return signal such that the return signal incident on the detector lens is collimated.

15. The laser range finder of claim 13, wherein at least one of the detector lens, the re-collimation lens, and the re-focusing lens has a planar surface facing and substantially perpendicular to the return signal in a collimated state, the laser range finder further comprising:
an optical band pass filter on the planar surface.

16. The laser range finder of claim 15, wherein the detector lens is a planoconvex lens having a planar input surface substantially perpendicular to the return signal, and a convex output surface facing the focal point of the detector lens, the laser range finder further comprising:
an optical band pass filter on the planar input surface of the detector lens.

17. The laser range finder of claim 13, wherein a focal length of the re-collimation lens is substantially the same as the second focal length to generate a one-to-one image relay from an input of the re-collimation lens to an output of the re-focusing lens.

18. A spatial filter, comprising:
a detector lens to focus collimated, incident light at a first focal point, the detector lens having a first focal length;
a light barrier surface having a pinhole aperture to allow light focused by the detector lens to pass through the light barrier surface;
a re-collimation lens to collimate the light from the pinhole aperture into re-collimated light; and
a re-focusing lens to focus the re-collimated light at a second focal point, the re-focusing lens having a second focal length that is shorter than the first focal length.

19. The spatial filter of claim 18, wherein at least one of the detector lens, the re-collimation lens and the re-focusing lens has a planar surface facing and substantially perpendicular to collimated light, the spatial filter further comprising:
an optical band pass filter on the planar surface.

20. The spatial filter of claim 18, wherein the detector lens is a planoconvex lens having a planar input surface substantially perpendicular to the collimated, incident light, and a convex output surface facing the first focal point, the spatial filter further comprising:
an optical band pass filter on the planar input surface of the detector lens.
